(19) United States
(12) Patent Application Publication
(10) Pub. No.: US 2010/0031935 A1
(43) Pub. Date: Feb. 11, 2010

(54) SUPER-TURBOCHARGER HAVING A HIGH SPEED TRACTION DRIVE AND A CONTINUOUSLY VARIABLE TRANSMISSION

(76) Inventors: Ed VanDyne, Loveland, CO (US); Barry T. Brinks, Fort Collins, CO (US); Michael B. Riley, Fort Collins, CO (US)

Correspondence Address: COCHRAN FREUND & YOUNG LLC, 2026 CARIBOU DR, SUITE 201, FORT COLLINS, CO, 80525, US

(21) Appl. No.: 12/536,421

(22) Filed: Aug. 5, 2009

Related U.S. Application Data
(60) Provisional application No. 61/086,401, filed on Aug. 5, 2008.

(51) Int. Cl. F02B 33/00; F16H 15/04; F16H 13/08; F16H 15/50

(52) U.S. Cl. 123/559.1; 476/47; 475/196; 475/185

(57) ABSTRACT

A super-turbocharger utilizing a high speed, fixed ratio traction drive that is coupled to a continuously variable transmission to allow for high speed operation is provided. A high speed traction drive is utilized to provide speed reduction from the high speed turbine shaft. A second traction drive provides infinitely variable speed ratios through a continuously variable transmission.

### CROSS-REFERENCE TO RELATED APPLICATION

This patent application claims the benefit of U.S. Provisional Patent Application Ser. No. 61/086,401, filed Aug. 5, 2008, the entire teachings and disclosure of which are incorporated by reference thereto.

### BACKGROUND OF THE INVENTION

Conventional turbochargers are driven by waste exhaust heat and gases, which are forced through an exhaust turbine housing onto a turbine wheel. The turbine wheel is connected by a common turbo-shaft to a compressor wheel. As the exhaust gases hit the turbine wheel, both wheels simultaneously rotate. Rotation of the compressor wheel draws air in through a compressor housing, which forces compressed air into the engine cylinder to achieve improved engine performance and fuel efficiency. Turbochargers for variable speed/load applications are typically sized for maximum efficiency at torque peak speed in order to develop sufficient boost to reach peak torque. However, at lower speeds, the turbocharger produces inadequate boost for proper engine transient response.

To overcome these problems and provide a system that increases efficiency, a super-turbocharger can be used, which combines the features of a supercharger and a turbocharger. Super-turbochargers merge the benefits of a supercharger, which is primarily good for high torque at low speed, and a turbocharger, which is usually only good for high horsepower at high speeds. A super-turbocharger combines a turbocharger with a transmission that can put engine torque onto the turbo shaft for supercharging and elimination of turbo lag. Once the exhaust energy begins to provide more work than it takes to drive the compressor, the super-turbocharger recovers the excess energy by applying the additional power to the piston engine, usually through the crankshaft. As a result, the super-turbocharger provides both the benefits of low speed with high torque and the added value of high speed with high horsepower all from one system.

### SUMMARY OF THE INVENTION

An embodiment of the present invention may therefore comprise a super-turbocharger that is coupled to an engine comprising: a turbine that generates turbine rotational mechanical energy from enthalpy of exhaust gas produced by the engine; a compressor that compresses intake air and supplies compressed air to the engine in response to the turbine rotational mechanical energy generated by the turbine and engine rotational mechanical energy transferred from the engine; a shaft having end portions that are connected to the turbine and the compressor, and a central portion having a shaft traction surface; a traction drive disposed around the central portion of the shaft, the traction drive comprising: a plurality of planetary rollers having a plurality of planetary roller traction surfaces that interface with the shaft traction surface so that a first plurality of traction interfaces exist between the plurality of planetary roller traction surfaces and the shaft traction surface; a ring roller that is rotated by the plurality of planet rollers through a second plurality of traction interfaces; a continuously variable transmission, that is mechanically coupled to the traction drive and the engine, that transfers turbine rotational mechanical energy to the engine and engine rotational mechanical energy to the super-turbocharger at operating speeds of the engine.

An embodiment of the present invention may further comprise a method of transferring rotational mechanical energy between a super-turbocharger and an engine comprising: generating turbine rotational mechanical energy in a turbine from enthalpy of exhaust gas produced by the engine; compressing intake air to supply compressed air to the engine in response to the turbine rotational mechanical energy generated by the turbine and engine rotational mechanical energy generated by the engine; providing a shaft having end portions that are connected to the turbine and the compressor, and a central portion having a shaft traction surface; mechanically coupling a traction drive to the shaft traction surface of the shaft; placing a plurality of planetary roller traction surfaces of a plurality of planetary rollers in contact with the shaft traction surface so that a plurality of first traction interfaces are created between the plurality of planetary roller traction surfaces and the shaft traction surface; placing a ring roller in contact with the plurality of planetary rollers so that a plurality of second traction interfaces are created between the plurality of planet rollers and the ring roller; mechanically coupling a continuously variable transmission to the traction drive and the engine to transfer the turbine rotational mechanical energy to the engine and engine rotational mechanical energy to the super-turbocharger at operating speeds of the engine.

### BRIEF DESCRIPTION OF THE DRAWINGS

FIG. 1 is a side view illustration of an embodiment of a super-turbocharger.

FIG. 2 is a transparency isometric view of the embodiment of the super-turbocharger of FIG. 1.

FIG. 3A is a side transparency view of an embodiment of the super-turbocharger illustrated in FIGS. 1 and 2.

FIG. 3B is a side cutaway view of another embodiment of a super-turbocharger.

FIGS. 4-9 are various drawings of a super-turbocharger using an embodiment of a multi-diameter planetary roller traction drive.

FIG. 10 is an illustration of another embodiment of a high speed traction drive.

FIGS. 11 and 12 are illustrations of an embodiment of a traction continuously variable transmission.

FIG. 13 is a side cutaway view of another embodiment.

FIG. 14 is a side view of another embodiment.

FIG. 15 is a graphical illustration of simulated BSFC improvement.

### DETAILED DESCRIPTION OF THE INVENTION

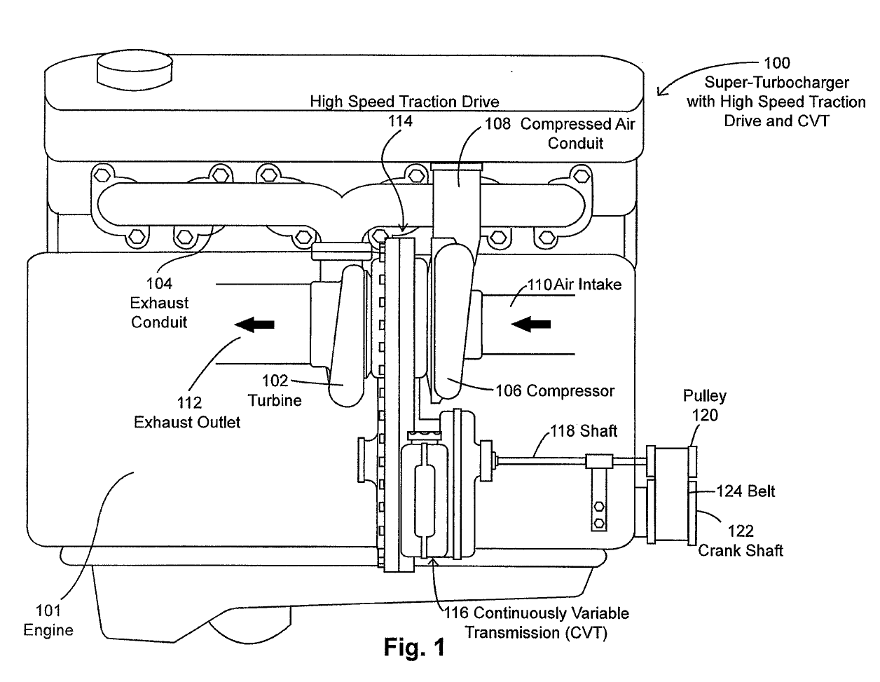

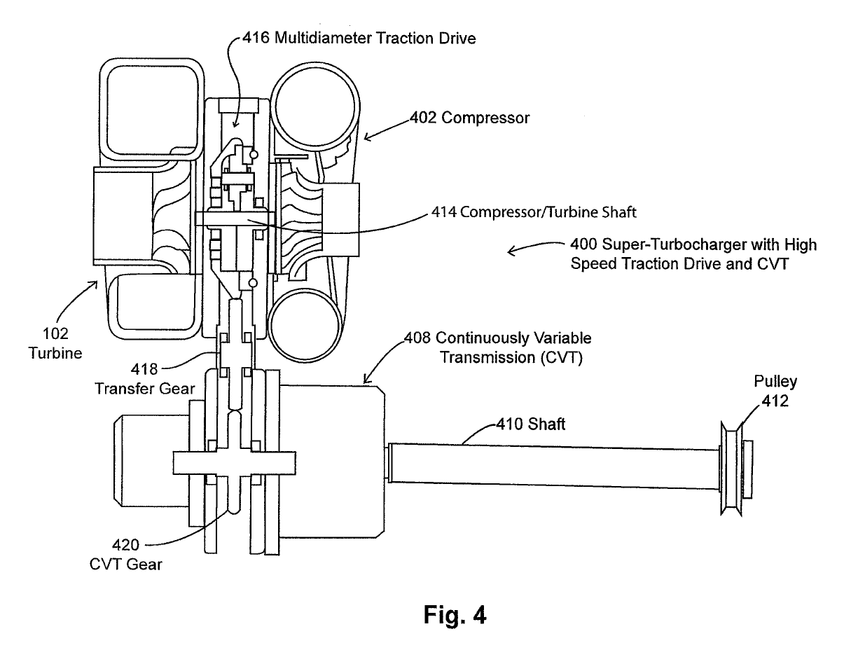

FIG. 1 is a schematic illustration of an embodiment of a super-turbocharger 100 that uses a high speed traction drive 114 and a continuously variable transmission 116. As shown in FIG. 1, the super-turbocharger 100 is coupled to the engine 101. The super-turbocharger includes a turbine 102 which is coupled to engine 101 by an exhaust conduit 104. The turbine 102 receives the hot exhaust gases from the exhaust conduit 104 and generates rotational mechanical energy prior to exhausting the exhaust gases in an exhaust outlet 112. A catalytic converter (not shown) can be connected between the exhaust conduit 104 and turbine 102. Alternatively, the catalytic converter (not shown) can be connected to the exhaust outlet 112. The rotational mechanical energy generated by the turbine 102 is transferred to the compressor 106 via a turbine/compressor shaft, such as shaft 414 of FIG. 4, to rotate a compressor fan disposed in the compressor 106, which compresses the air intake 110 and transmits the compressed air to a conduit 108, which is coupled to an intake manifold (not shown) of the engine 101. As disclosed in the above referenced application, super-turbochargers, unlike turbochargers, are coupled to a propulsion train to transfer energy to and from the propulsion train. The propulsion train may be the engine 101, the transmission of a vehicle in which the engine 101 is disposed, the drive train of a vehicle in which the engine 101 is disposed, or other applications of the rotational mechanical energy generated by engine 101. In other words, rotational mechanical energy can be coupled or transferred from the super-turbocharger to the engine through at least one intermediate mechanical device such as a transmission or drive train of a vehicle, and vice versa. In the embodiment of FIG. 1, the rotational mechanical energy of the super-turbocharger is coupled directly to a crankshaft 122 of engine 101 through a shaft 118, a pulley 120 and a belt 124. As also illustrated in FIG. 1, a high speed traction drive 114 is mechanically coupled to a continuously variable transmission 116.

In operation, the high speed traction drive 114, of FIG. 1, is a fixed ratio, high speed traction drive that is mechanically coupled to the turbine/compressor shaft using a traction interface to transfer rotational mechanical energy to and from the turbine/compressor shaft. The high speed traction drive 114 has a fixed ratio which may differ in accordance with the size of the engine 101. For small engines, a large fixed ratio of the high speed traction drive 114 is required.

For smaller engines, the compressor and turbine of a super-turbocharger must necessarily be smaller to maintain a small engine size and to match the flow requirements of the compressor and turbine. In order for a smaller turbine and a smaller compressor to function properly, they have to spin at a higher rpm. For example, smaller engines may require the compressor and turbine to spin at 300,000 rpm. For very small engines, such as half liter engines, the super-turbocharger may need to spin at 900,000 rpm. One of the reasons that smaller engines require compressors that operate at a higher rpm level is to avoid surge. In addition, to operate in an efficient manner, the tip velocity of the compressor must be just short of the speed of sound. Since the tips are not as long in smaller compressors, the tips of a smaller compressor are not moving as fast as the tips on larger compressors at the same rpm. As the size of the compressor decreases, the rotational speed required to operate efficiently goes up exponentially. Since gears are limited to approximately 100,000 rpm, standard gear systems cannot be used to achieve the power take off at the higher speeds necessary for a car engine super-turbocharger. Therefore, various embodiments use a high speed traction drive 114 to add and receive power from the turbo shaft.

The rotational mechanical energy from the high speed traction drive 114 is therefore reduced to an rpm level that is variable depending upon the rotational speed of the turbine/compressor, but at an rpm level that is within the operating range of the continuously variable transmission (CVT) 116. For example, the high speed traction drive 114 may have an output that varies between zero and 7,000 rpm while the input from the turbine/compressor shaft may vary from zero to 300,000 rpm, or greater. The continuously variable transmission 116 adjusts the rpm level of the high speed traction drive 114 to the rpm level of the crankshaft 122 and pulley 120 to apply rotational mechanical energy to engine 101, or extract rotational mechanical energy from engine 101 at the proper rpm level. In other words, the continuously variable transmission 116 comprises an interface for transferring rotational mechanical energy between engine 101 and the high speed traction drive 114 at the proper rpm level which varies in accordance with the engine rotational speed and the turbine/compressor rotational speed. Continuously variable transmission 116 can comprise any desired type of continuously variable transmission that can operate at the required rotational speeds and have a ratio to match the rotational speed of the crankshaft 122 or other mechanism connected to the engine 101, which is referred to herein as the propulsion train. For example, in addition to the embodiments disclosed herein, two roller CVTs can be used as well as traction ball drives and pushing steel belt CVTs.

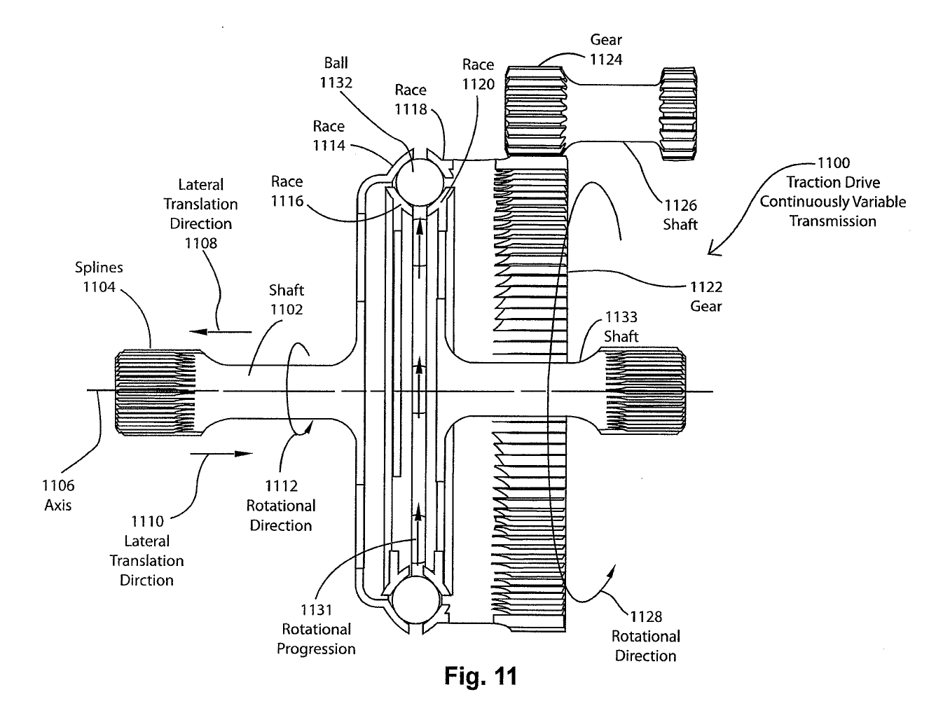

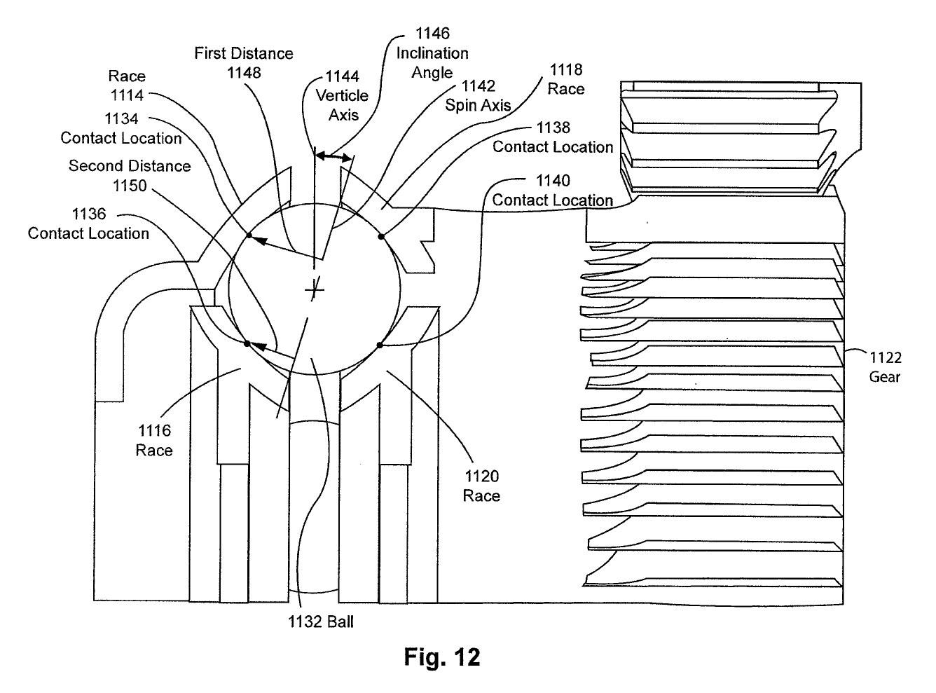

An example of a continuously variable transmission that is suitable for use as continuously variable transmission 116, disclosed in FIG. 1, is the continuously variable transmission disclosed in FIGS. 11 and 12. Other examples of continuously variable transmissions that can be used as the continuously variable transmission 116 of FIG. 1 include U.S. Pat. No. 7,540,881 issued Jun. 2, 2009, to Miller et al. The Miller patent is an example of a traction drive, continuously variable transmission that uses a planetary ball bearing. The traction drive of Miller is limited to about 10,000 rpm so that the Miller continuously variable transmission is not usable as a high speed traction drive, such as high speed traction drive 114. However, the Miller patent does disclose a continuously variable transmission that uses a traction drive and is suitable for use as an example of a continuously variable transmission that could be used as continuously variable transmission 116 as illustrated in FIGS. 1-3. Another example of a suitable continuously variable transmission is disclosed in U.S. Pat. No. 7,055,507 issued Jun. 6, 2006, to William R. Kelley, Jr., and assigned to Borg Warner. Another example of a continuously variable transmission is disclosed in U.S. Pat. No. 5,033,269 issued Jul. 23, 1991 to Smith. Further, U.S. Pat. No. 7,491,149 also discloses a continuously variable transmission that would be suitable for use as continuously variable transmission 116. U.S. Pat. No. 7,491,149 issued Feb. 17, 2009 to Greenwood et al. and assigned to Torotrak Limited discloses an example of a continuously variable transmission that uses a traction drive that can be used as the continuously variable transmission 116. All of these patents are specifically incorporated by reference for all that they disclose and teach. European Application No. 92830258.7, published Aug. 9, 1995, as Publication No. 0517675B1, also illustrates another continuously variable transmission 3 that is suitable for use as the continuously variable traction drive 116.

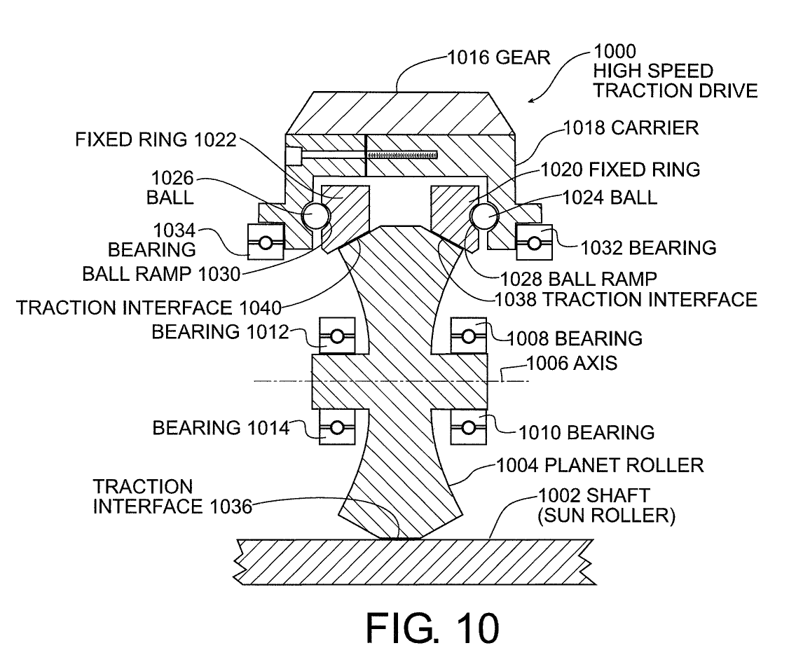

Various types of high speed traction drives can be used as the high speed traction drive 114. For example, the high speed planetary traction drive 406 disclosed in FIGS. 4-9 and the high speed planetary drive of FIG. 10 can be used as high speed traction drive 114.

Examples of high speed drives that use gears are disclosed in U.S. Pat. No. 2,397,941 issued Apr. 9, 1946 to Birgkigt and U.S. Pat. No. 5,729,978 issued Mar. 24, 1998 to Hiereth et al. Both of these patents are specifically incorporated herein by reference for all that they disclose and teach. Both of these references use standard gears and do not use traction drives. Hence, even with highly polished, specially designed gearing systems, the gears in these systems are limited to rotational speeds of approximately 100,000 rpm or less. U.S. Pat. No. 6,960,147 issued Nov. 1, 2005 to Kolstrup and assigned to Rulounds Roadtracks Rotrex A/S discloses a planetary gear that is capable of producing gear ratios of 13:1. The planetary gear of Kolstrup is an example of a high speed drive that could be used in place of a high speed traction drive 114 of FIG. 1. U.S. Pat. No. 6,960,147 is also specifically incorporated herein by reference for all that it disclosed and teaches.

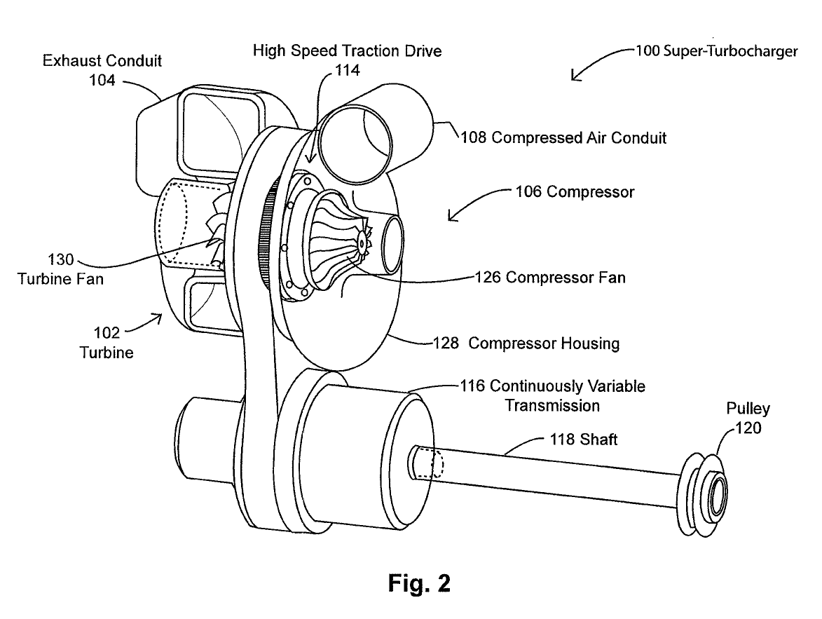

FIG. 2 is a schematic side transparency view of the super-turbocharger 100. As shown in FIG. 2, turbine 102 has an exhaust conduit 104 that receives exhaust gases that are applied to the turbine fan 130. Compressor 106 has a compressed air conduit 108 that supplies compressed air to the intake manifold. Compressor housing 128 encloses the compressor fan 126 and is coupled to the compressed air conduit 108. As disclosed above, high speed traction drive 114 is a fixed ratio traction drive that is coupled to a continuously variable transmission 116. The continuously variable transmission 116 drives shaft 118 and pulley 120.

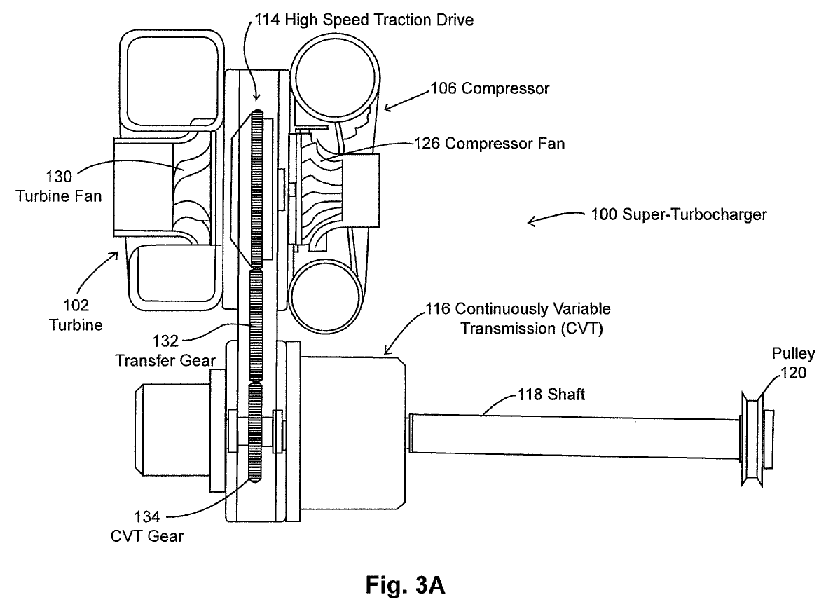

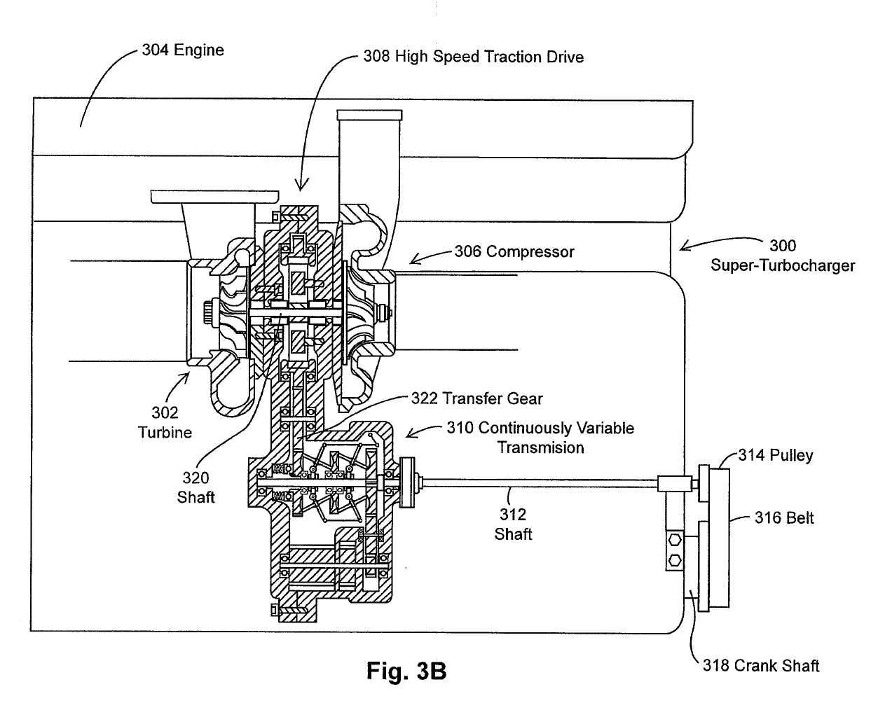

FIG. 3A is a side transparency view of the embodiment of the super-turbocharger 100 illustrated in FIGS. 1 and 2. Again, as shown in FIG. 3A, turbine 102 includes a turbine fan 130, while compressor 106 includes a compressor fan 126. A shaft (not shown) connecting the turbine fan 130 and compressor fan 126 is coupled to a high speed traction drive 114. Rotational mechanical energy is transferred from the high speed traction drive 114 to a transfer gear 132 that transfers the rotational mechanical energy to a CVT gear 134 and the continuously variable transmission (CVT) 116. The continuously variable transmission 116 is coupled to the shaft 118 and pulley 120.

FIG. 3B is a schematic cutaway view of another example of a super-turbocharger 300 that is coupled to an engine 304. As shown in FIG. 3B, the turbine 302 and the compressor 306 are mechanically coupled by shaft 320. High speed traction drive 308 transfers rotational mechanical energy to, and receives rotational mechanical energy from, the high speed traction drive 308. A specific example of a high speed traction drive 308 is illustrated in FIG. 3B. Transfer gear 322 transfers rotational mechanical energy between the traction drive 308 and the continuously variable transmission 310. A specific example of a continuously variable transmission 310 is also illustrated in FIG. 3B. Shaft 312, pulley 314 and belt 316 transfer rotational mechanical energy between the crankshaft 318 and the continuously variable transmission 310.

FIG. 4 is a schematic transparency view of another embodiment of super-turbocharger 400 that utilizes a high speed traction drive 416 that is coupled to a continuously variable transmission 408. As shown in FIG. 4, the turbine 404 is mechanically coupled to the compressor 402 with a compressor/turbine shaft 414. Rotational mechanical energy is transferred between the compressor/turbine shaft 414 and the multi-diameter traction drive 416 in the manner disclosed in more detail below. Transfer gear 418 transfers rotational mechanical energy between the multi-diameter traction drive 416 and the CVT gear 420 of the continuously variable transmission 408. Shaft 410 and pulley 412 are coupled to the continuously variable transmission 408 and transfer power between the continuously variable transmission 408 and a propulsion train.

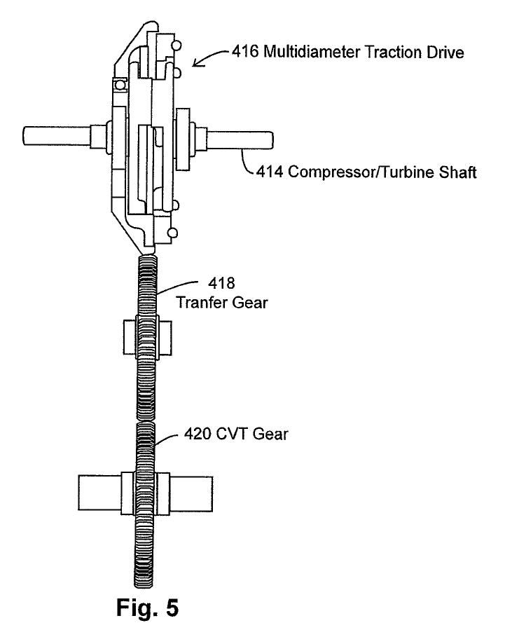

FIG. 5 is a side cutaway schematic view of the multi-diameter traction drive 416 that is coupled to the transfer gear 418, which is in turn coupled to the CVT gear 420. The compressor/turbine shaft 414 has a polished, hardened surface on a central portion, as disclosed in more detail below, that functions as a sun drive in the multi-diameter traction drive 416.

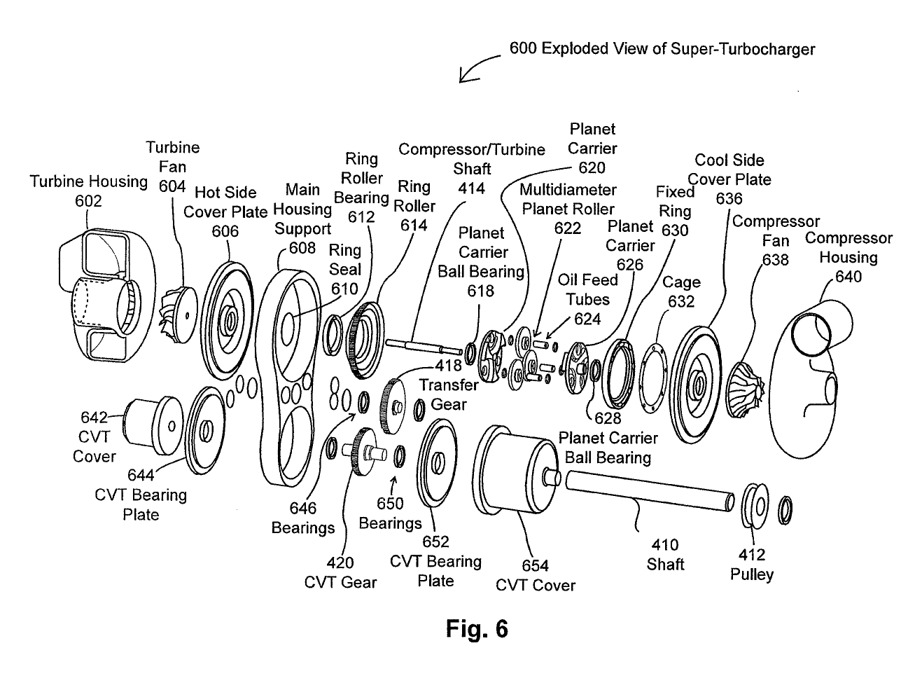

FIG. 6 is an exploded view 600 of the embodiment of the super-turbocharger 400 illustrated in FIG. 4. As shown in FIG. 6, turbine housing 602 houses a turbine fan 604. The hot side cover plate 606 is mounted adjacent to the turbine fan 604 and the main housing support 608. A ring seal 610 seals the exhaust at the hot side cover plate 606. Ring roller bearing 612 is mounted in the ring roller 614. Compressor/turbine shaft 414 extends through the main housing support 608. The hot side cover plate 606 connects with the turbine fan 604. Planet carrier ball bearing 618 is mounted on the planet carrier 620. Multi-diameter ring rollers 622 are rotationally connected to the planet carrier 620. Oil feed tubes 624 are used to supply traction fluid to the traction surface. Planet carrier 626 is mounted to the planet carrier 620 and uses a planet carrier ball bearing 628. Fixed ring 630 is then mounted outside of planet carrier 626. Cage 632 is mounted between the fixed ring 630 and the cool side cover plate 636. Compressor fan 638 is coupled to the compressor/turbine shaft 414. Compressor housing 640 encloses the compressor fan 638. The main housing support 608 also supports the continuously variable transmission and the transfer gear 418. Various bearings 646 are used to mount the transfer gear 418 and the main housing support 608. The continuously variable transmission includes a CVT cover 642 and a CVT bearing plate 644. CVT gear 420 is mounted inside the main housing support 608 with bearings 650. CVT bearing plate 652 is mounted on the opposite side of the CVT gear 420 from the CVT bearing plate 644. CVT cover 654 covers the various portions of the CVT device. Shaft 410 is coupled to the continuously variable transmission. Pulley 412 is mounted on shaft 410 and transfers rotational mechanical energy between shaft 410 and a propulsion train.

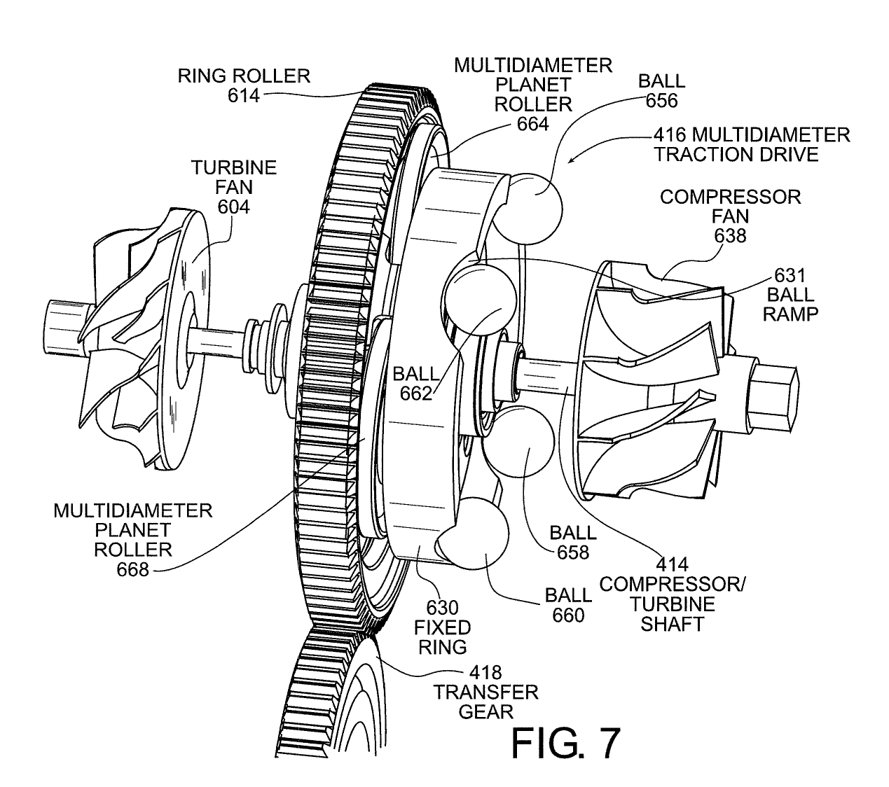

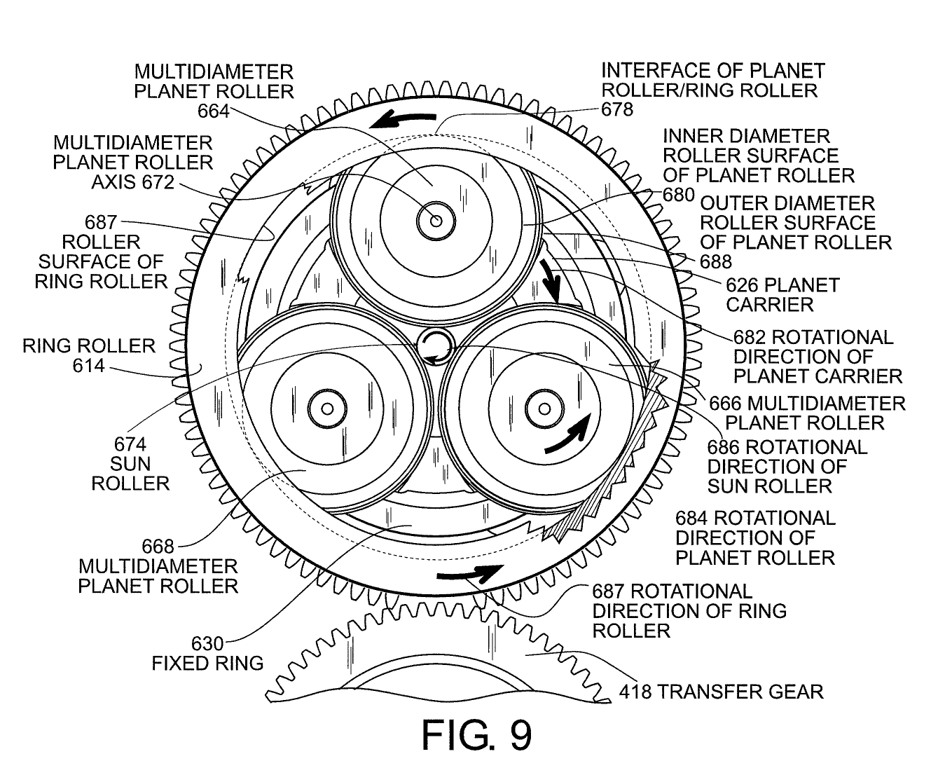

FIG. 7 is a perspective view of isolated key components of the multi-diameter traction drive 416, as well as the turbine fan 604 and compressor fan 638. As shown in FIG. 7, the compressor/turbine shaft 414 is connected to the turbine fan 604 and compressor fan 638, and passes through the center of the multi-diameter traction drive 416. The multi-diameter traction drive 416 includes multi-diameter planet rollers 664, 666 (FIG. 9), 668. These multi-diameter planet rollers are rotationally coupled to a planet carrier 626 (FIG. 9). Balls 656, 658, 660, 662 rest on an incline surface for ball ramps on the fixed ring 630. Ring roller 614 is driven by an inner diameter of the multi-diameter planet rollers 664, 666, 668, as disclosed in more detail below.

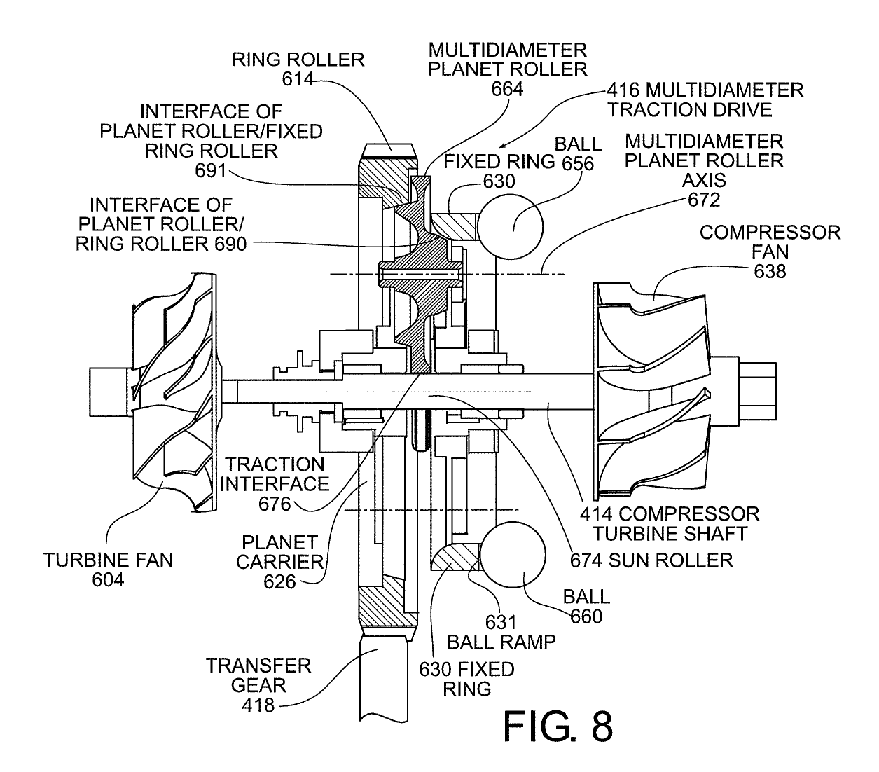

FIG. 8 is a side cutaway view of the multi-diameter traction drive 416. As shown in FIG. 8, the compressor/turbine shaft 414 is hardened and polished to form a traction surface that is used as a sun roller 674 that has a traction interface 676 with the multi-diameter planet roller 664. The multi-diameter planet roller 664 rotates along the multi-diameter planet roller axis 672. The multi-diameter planet roller 664 contacts the fixed ring 630 at the interface 690 of the planet roller 664 and the fixed ring 630. The multi-diameter planet roller 664 contacts the ring roller 614 at interface 691, which is a different radial distance from the multi-diameter planet roller axis 672, than the interface 691. FIG. 8 also illustrates the planet carrier 626 and the ball ramp 630 that intersects with the ball 656, and ball ramp 631 that intersects with ball 660. The balls 656, 658, 660, 662 are wedged in between a housing (not shown) and the ball ramp, such as ball ramp 630, on the fixed ring 664. When torque is applied to the ring roller 614, this causes the fixed ring 664 to move slightly in the direction of the rotation of the ring roller 614. This causes the balls to move up the various ball ramps, such as ball ramps 630, 631, which in turn causes the fixed ring 630 to press against the multi-diameter planet rollers 664, 666, 668. Since the interface 691 of the planet roller 664 and fixed ring 630 is sloped, and the interface of the planet roller 664 and ring roller 690 is sloped, an inward force on the multi-diameter planet roller 664 is generated, which generates a force on the traction interface 676 to increase the traction at the traction interface 676 between the multi-diameter planet roller 664 and the sun roller 674. In addition, a force is created at the interface 691 of the multi-diameter planet roller 664 and the ring roller 614, which increases traction at interface 691. As also shown in FIG. 8, the compressor fan 630 and the turbine fan 604 are both coupled to the compressor/turbine shaft 414. Ring roller 614 is coupled to the transfer gear 418, as also shown in FIG. 8.

FIG. 9 is a side cutaway view of the multi-diameter traction drive 416. As shown in FIG. 9, the sun roller 674 rotates in a clockwise direction, as shown by rotation direction 686. The multi-diameter planet rollers 664, 666, 668 have outer diameter roller surfaces, such as outer diameter roller surface 688 of multi-diameter planet roller 664. These outer diameter roller surfaces contact the sun roller 674 which cause the multi-diameter planet rollers 664, 666, 668 to rotate in a counter-clockwise direction, such as rotational direction 684 of multi-diameter planet roller 666. The multi-diameter planet rollers 664, 666, 668 also have an inner diameter roller surface, such as inner roller diameter roller surface 680 of multi-diameter planet roller 664. The inner diameter roller surface of each multi-diameter planet roller contacts the roller surface 687 of the ring roller 614. Hence, the interface 678 of planet roller 664 with the roller surface 687 of ring roller 614 constitutes a traction interface that transfers rotational mechanical energy when a traction fluid is applied. The interface between each of the multi-diameter planet rollers 664, 666, 668 and sun roller 674 also constitutes a traction interface that transfers rotational mechanical energy upon application of a traction fluid.

As indicated above with respect to FIGS. 8 and 9, the fixed ring 630 generates a force, which pushes the multi-diameter planet rollers 664, 666, 668 towards the sun roller 674 to generate traction. Each of the multi-diameter planet rollers 664, 666, 668 is rotationally attached to the planet carrier 626 with planet roller axes, such as the multi-diameter planet roller axis 672 of the multi-diameter planet roller 664. These axes have a slight amount of play so that the multi-diameter planet rollers 664, 666, 668 can move slightly and create a force between the sun roller 674 and the outer diameter roller surface of the multi-diameter planet rollers 664, 666, 668, such as the outer diameter of the roller surface 688 of the planet roller 664. The movement of the multi-diameter planet roller 664 towards the sun roller 674 also increases the traction at the interface of the multi-diameter planet rollers 664, 666, 668 and the ring roller 614, since the interface between the multi-diameter planet rollers 664, 666, 668 and the ring roller 614, such as interface 678, is sloped. The contact with the multi-diameter planet rollers 664, 666, 668 with the roller surface 687 of ring roller 614 causes the planet carrier 626 to rotate in a clockwise direction, such as the rotational direction 682, illustrated in FIG. 9. As a result, the ring roller 614 rotates in a counter-clockwise direction, such as rotational direction 687, and drives the transfer gear 418 in a clockwise direction.

FIG. 10 is a schematic cross sectional view of another embodiment of a high speed traction drive 1000. As shown in FIG. 10, a shaft 1002, which is a shaft, that connects a turbine and a compressor in super-turbocharger, can act as a sun roller in the high speed traction drive 1000. Planet roller 1004 contacts the shaft 1002 at traction interface 1036. Planet roller 1004 rotates on an axis 1006 using bearings 1008, 1010, 1012, 1014. As also shown in FIG. 10, gear 1016 is disposed and connected to the outer surface of the carrier 1018. Carrier 1018 is coupled to a housing (not shown) via bearings 1032, 1034, which allow the carrier 1018 and gear 1016 to rotate. Fixed rings 1020, 1022 include ball ramps 1028, 1030, respectively. Ball ramps 1028, 1030 are similar to the ball ramps 630 illustrated in FIGS. 7 and 8. As the gear 1016 moves, the balls 1024, 1026 move in the ball ramps 1028, 1030, respectively, and force the fixed rings 1020, 1022 inwardly towards each other. A force is created between the fixed rings 1020, 1022 and the surface of the planet roller 1004 at traction surfaces 1038, 1040 as the balls 1024, 1026 force the fixed ramps 1020, 1022 inwardly towards each other. The force created by the fixed rings 1020, 1022 also forces the planet roller 1004 downwardly, as illustrated in FIG. 10, so that a force is created between the shaft 1002 and the planet roller 1004 at the traction interface 1036. As a result, greater traction is achieved at a traction interface 1036 and the traction surfaces 1038, 1040. Traction fluid is applied to these surfaces, which becomes sticky and increases friction at the traction interfaces, as the traction fluid is heated as a result of the friction created at the traction interfaces 1036, 1038, 1040.

The high speed traction drive 1000, illustrated in FIG. 10, is capable of rotating at high speeds in excess of 100,000 rpm, which is unachievable by gearing systems. For example, the high speed traction drive 1000 may be able to rotate at speeds greater than 300,000 rpm. However, high speed traction drive 1000 is limited to a gear ratio of approximately 10:1 because of the physical limitations of size. The high speed traction drive 1000 may utilize three planet rollers, such as planet roller 1006 that are disposed radially around the shaft 1002. As illustrated in FIG. 9, the size of the planet rollers is limited with respect to the sun roller. If the diameter of the planet rollers in FIG. 9 increases, the planet rollers will abut each other. Hence, gear ratios of only about 10:1 can be reached with a planetary traction drive, such as illustrated in FIG. 10, while the multi-diameter planet drives that are connected to a planet carrier, such as illustrated in FIGS. 7-9, may have ratios of as much as 47:1 or greater. Accordingly, if a compressor is required for a smaller engine that must rotate at 300,000 rpm to be efficient, a 47:1 ratio traction drive, such as illustrated in FIGS. 7-9, can reduce the maximum rotational speed of 300,000 rpm to approximately 6,400 rpm. Standard geared or traction continuously variable transmissions can then be used to transfer the rotational mechanical energy between the high speed traction drive and the propulsion train of the engine.

As disclosed above, the high speed traction drive 1000, illustrated in FIG. 10, may have a ratio as large as 10:1. Assuming a rotational speed of the shaft 1002 is 300,000 rpm for a super-turbocharger for a small engine, the 300,000 rpm rotational speed of the shaft can be reduced to 30,000 rpm at gear 1016. Various types of continuously variable transmissions 116 can be used that operate up to 30,000 rpm using standard gearing techniques. Traction drive continuously variable transmissions, such as the traction drive continuously variable transmission illustrated in FIGS. 11 and 12, can also be used as the continuously variable transmission 116, illustrated in FIG. 1. Further, ratios of up to 100:1 may be achievable with the multi-diameter traction drive 416, illustrated in FIG. 4-9. Accordingly, small engines of 0.5 liters, which may require a compressor that operates at 900,000 rpm, can be reduced to 9,000 rpm, which is a rotational speed that can be easily utilized by various continuously variable transmissions 116 to couple rotational mechanical energy between a propulsion train and a turbine/compressor shaft.

FIGS. 11 and 12 illustrate an example of a traction drive continuously variable transmission that can be used as the continuously variable transmission 116 of FIG. 1. The traction drive continuously variable transmission illustrated in FIGS. 11 and 12 operates by translating races 1116, 1118 in a lateral direction on race surfaces that have a radius of curvature that causes contact locations of the ball bearings to move, which, in turn, causes the balls to rotate with a different spin angle to drive the races 1114-1120 at a different speed. In other words, the contact location of each of the bearings on the race surfaces is changed as a result of the lateral translation of the races 1116, 1118, which alters the speed at which the bearing is rotating at the contact location, as explained in more detail below.

As shown in FIG. 11, shaft 1102 is coupled to the transfer gear 132. For example, splines 1104 may be splined to the CVT gear 134, illustrated in FIG. 3A. Shaft 1102 rotates around the shaft axis 1106. Race 1114 is rotatably coupled to shaft 1102 so that race 1114 also rotates around shaft axis 1106. In that regard, race 1114 can be splined to shaft 1102 and coupled to the frame so that race 1114 does not translate in a lateral direction, such as lateral translation direction 1108 or lateral translation direction 1110. Race 1116 also rotates with the shaft 1102 and can move in a lateral translation direction, such as lateral translation directions 1108, 1110 by moving the shaft 1102 through the use of splines 1104. In addition, race 1116 may be coupled to the shaft 1102 so that race 1116 rotates at a fixed ratio to the rotation of shaft 1102. Race 1118 also rotates around axis 1106 that is fixed so that race 1118 does not translate in either lateral directions 1108, 1110. Race 1118 is secured to the gear 1122, which transfers rotational mechanical energy to gear 1124, which may be coupled to shaft 118 of FIG. 1. Race 1120 is fixed to shaft 1133, which does not rotate or translate. Races 1116, 1118 laterally translate in lateral translation directions 1108, 1110, simultaneously, which causes the contact locations, illustrated in FIG. 12, to change as well as the spin axis 1142, illustrated in FIG. 12, to change. Ball 1132, as well as the other balls illustrated in FIG. 11, has a rotational progression 1131 in the four races 1114, 1116, 1118, 1120. The rotational direction 1112 of the shaft 1102 causes the gear 1122 to rotate in a rotational direction 1128, illustrated in FIG. 11.

FIG. 12 is a closeup view of the races 1114-1120 and ball 1132 illustrating the operation of the traction drive, continuously variable transmission 1100. As shown in FIG. 12, race 1114 forcibly contacts ball 1132 at contact location 1134. Race 1116 forcibly contacts ball 1132 at contact location 1136. Race 1118 forcibly contacts ball 1132 at contact location 1138. Race 1120 forcibly contacts ball 1132 at contact location 1140. Each of the contact locations 1134, 1136, 1138, 1140 is located on a common great circle on the surface of the ball 1132. The great circle is located in a plane that contains the center of the ball 1132 and the axis 1106 of the shaft 1102. Ball 1132 spins about a spin axis 1142 passing through the center of the ball 1132 and bisects the great circle containing contact locations 1134, 1136, 1138, 1140. The spin axis 1142 of the ball 1132 is inclined at an angle 1146 with the vertical axis 1144. The inclination angle 1146 is the same for each of the balls disposed in the races around the circumference of the traction drive 1100. The inclination angle 1146 establishes a mathematical relationship between a distance ratio and a circumferential velocity ratio. The distance ratio is the ratio between the first distance 1148, which is the orthogonal distance from the spin axis 1142 to the contact location 1134, and a second distance 1150, which is the orthogonal distance from the spin axis 1142 to contact location 1136. This distance ratio is equal to the circumferential velocity ratio. The circumferential velocity ratio is the ratio between the first circumferential velocity and the second circumferential velocity, where the first circumferential velocity is the difference between the circumferential velocity of ball 1132 at race 1114 and a common orbital circumferential velocity of ball 1132 and the other balls in the races, while the second circumferential velocity is the difference between the circumferential velocity of the ball 1132 on the race 1116 and the common orbital circumferential velocity of the ball 1132, as well as the other balls disposed in the races. The radius of curvature of each of the races 1114-1120 is larger than the radius of curvature of ball 1132. In addition, the radius of curvature of each of the races 1114-1120 need not be a constant radius of curvature, but can vary. Further, the radius of curvature of each of the four races does not have to be equal.

When races 1116, 1118 translate simultaneously in a lateral direction, such as lateral translation direction 1108, the speed ratio of the rotation of shaft 1102 and the rotational direction 1112 change with respect to the rotation of the gear 1122 and rotational direction 1128. Translation of races 1116, 1118 in lateral translation direction 1108 causes the first distance 1148 to be larger and the second distance 1150 to be smaller. Hence, the ratio of distances, as well as the circumferential velocity ratio, changes, which changes the rotational speed of the gear 1122 with respect to shaft 1102.

As indicated above, the continuously variable transmission output is in gear contact with the traction drive speed reduction mechanism that connects to the turbine compressor shaft. As indicated above, there are at least two or three different types of traction drive speed reduction systems that may be used. The typical type is a planetary type traction drive for high speed reduction, which is disclosed in FIGS. 6-9, and FIG. 10. If a large speed differential between the turbine shaft and the planetary roller is desired, the embodiment of FIG. 10 may utilize only two rollers instead of three, in order to get the gear ratio change that is desired.

With three rollers, a limit of about a 10:1 reduction in speed exists and there may be a need for more like a 20:1 transmission to get the high speed 250,000 rpm operation below the 25,000 rpm to which a 10:1 transmission would be limited. Therefore, a two roller planetary traction drive can be used in place of a three planetary drive system, in FIG. 10, in order to achieve the speed reduction required of the smallest highest speed systems. Two rollers also provide for lower inertia, as each roller adds some amount of inertia to the system. For the lowest inertia, two rollers should be sufficient. The width of the traction roller is slightly wider than a three roller embodiment.

The multi-diameter planet rollers that roll against the shaft are made of a springy material, e.g., either a spring steel or another material, that allows some deformation of the roller within the outer drum. The application of a spring loaded roller can provide the necessary pressure on the shaft, but not restrict the shaft's ability to find its center of rotation.

When a turbocharger operates at extremely high speeds, it has balance constraints that cause the shaft to need to find its own center of rotation. The balance will be compensated by the movement of the center shaft. This movement can be compensated by spring-loaded rollers. The spring-loaded rollers can also be made extremely light weight by making them out of a thin band of steel that allows them to operate against the shaft with very low inertia. The band thickness must be thick enough to put sufficient pressure on the traction surfaces to provide the normal force needed for traction. A cam follower can be disposed inside the roller that will position each roller and hold that position within the system. Rollers need to operate in a very straight alignment between the outer drum and the turbine/compressor shaft, but the key to low inertia is lightweight. One or two cam followers can be utilized to hold the steel band in place, such that the steel band stays in alignment in the system.

The ring roller 614 is connected to a gear on the outside surface so that the ring roller can transmit the power in or out of the multi-diameter traction drive 416. The ring roller 614 can be made in numerous ways. Ring roller 614 can simply be a solid piece of steel or other appropriate material that is capable of transmitting the torque in and out of the multi-diameter traction drive 416. Ring roller 614 can be made of numerous materials that allow ring roller 614 to be lightweight, but ring roller 614 has to be from a material that can be used as a traction drive surface on the roller surface 687. A proper roller surface 687 allows the planet rollers 664, 666, 668 to transmit the torque through traction.

Also, turbine/compressor shaft 414 needs to be held in very accurate alignment. The alignment of the turbine/compressor shaft 414, within the housing, allows the clearances to be held between the tips of the blades of the compressor and the compressor housing. A tighter clearance increases the compressor efficiency. A more accurate position decreases the chance of touching between the turbine compressor fan 638 and the compressor housing 640. A method of controlling the thrust load that comes from compressing the gas against the compressor wheel is necessary to ensure that there is a minimum of clearance. This can be done using a thrust bearing (not shown) that is oil fed or a thrust bearing that is a ball bearing or roller bearing type of bearing.

Typically, in a turbocharger, the bearings are, for reliability purposes, sleeve bearings that have an oil clearance both on the inside and the outside in order to allow for the turbine shaft to center itself in its harmonic rotation. The balancing requirements for a high volume manufactured turbocharger are reduced by using a double clearance bearing. These bearing types have been used because of the requirement of tighter clearances and more accurate alignment of the shaft of the turbocharger. A ball bearing is used for both holding the compressor and turbine and for maintaining better alignment to the housing from a side-to-side motion perspective. This can be accomplished with one or two ball bearings. Alignment of bearings within an outer area that is pressurized with oil allows the bearings to float and allows the bearing to find a center. This does affect the clearance between the housing, turbine and compressor outside edges, but allows thrust clearance to remain small. Turbo shaft bearings provide a third point of constraint to maintain alignment of the rollers. Cam followers in the middle of the rollers can keep the rollers at 120 degrees from one another. Two small cam followers can be used for each roller to eliminate backlash when power changes direction.

Also, a larger turbine can be used. The turbine wheel can be made larger in diameter than normal. It is possible to make the turbine outer diameter even larger than the compressor wheel, without hitting the critical speed where tips come close to the speed of sound, because the density of the exhaust is lower than inlet air and therefore the speed of sound is higher. This allows the exhaust to generate more torque on the turbine/compressor shaft without higher backpressure. Having higher torque causes the turbine to recover more energy than is required to compress the intake air. This produces more energy than can be recovered and transmitted to the engine. More energy from the same exhaust gas flow that is not needed for compression gets transferred to the crankshaft and creates lower fuel consumption.

Further, turbine efficiency can be improved by using guide vanes that control the angle of incidence which exhaust gases impact the turbine wheel. This makes the peak efficiency higher, but narrows the speed range upon which that efficiency is achieved. A narrow speed range is bad for a normal turbocharger, and is not a problem for a super-turbocharger where the governor can provide the necessary speed control.

Higher backpressure across the turbine compared to the pressure across the compressor can also create an unbalanced super-turbocharger. For a normal turbocharger, this pressure difference is the other way around. Having higher backpressure causes the turbine to recover more energy than is required to compress the intake air. This produces more energy that can be recovered and transmitted to the engine. Higher backpressure is needed for high pressure EGR loops on diesel engines. High backpressure normally requires a valve or a restriction, so high backpressure is normally lost energy because a normal turbocharger cannot be unbalanced without over-speeding. Increasing backpressure is bad for gasoline and natural gas engines, because it increases the amount of exhaust gas that gets trapped in the cylinder, which makes the engine more likely to have detonation problems.

Also, a catalyst, a DPF or even a burner plus DPF can be positioned in front of the turbine of the super-turbocharger to heat the exhaust gas to a higher temperature than the heat of the engine. Higher temperatures expand the air even further making the flow rate across the turbine higher. Approximately 22% of this heat addition can be turned into mechanical work across the super-turbocharger, assuming 80% turbine efficiency. Normally, higher volume in the exhaust that is fed to the turbine would slow the turbine response and create even bigger turbo lag, but the super-turbocharger overcomes this problem with the traction drive 114 and continuously variable transmission 116 driving the pressure response.

Further, a second turbine wheel can be positioned on the turbine/compressor shaft to increase the energy recovered by the turbine and improve the fuel efficiency of the engine system. Also, a second compressor wheel can be positioned on the same shaft to increase the boost pressure potential of the super-turbocharger and allow intercooling between the stages. This makes the intake temperature cooler for a given boost and therefore lowers NOx.

In addition, turbine blade cooling can be provided through the wing tips to reduce temperatures in high temperature applications. This can be done with hollow wing tips at the outer edge of the turbine. This special tip design increases turbine efficiency and provides a path for cooling air to get through the blades.

In addition, a torsional softening device can be used on the power path. Crankshaft energy or rotational mechanical energy from a propulsion train can be brought through a flex shaft or an impulse softening device (either spring loaded or flexing) in such a way that torque impulses from the engine or propulsion train are removed without loss of that energy, before entering the housing. By not impacting the transmission with high torque spikes on the traction drive, the peak torque requirement is reduced. By eliminating these torque spikes, traction drives are more reliable, because the traction requirements are limited by the maximum torque on the system. By minimizing these torque spikes on the traction drives, the size and surface contact areas of the traction drives can be minimized. Minimal surface contact areas maximize efficiency of the system, and can still achieve the torque required for transmitting the continuous power.

Alternatively, and in accordance with another embodiment, a variable speed traction drive design with fixed displacement hydraulic pumps in place of the shaft, belt or gear drive may be utilized. This makes the system easier to package, which could be especially useful on very big engines having multiple turbochargers.

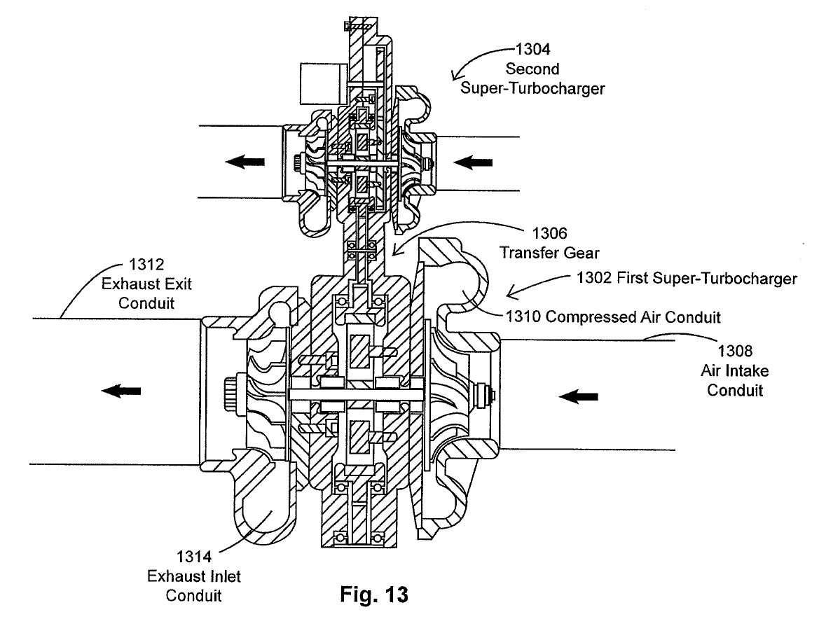

In a further embodiment, illustrated in FIG. 13, a second super-turbocharger is run off one transmission as a way to get a higher pressure ratio, and as a way to get cooler intake temperatures by using a second intercooler. This is possible with a fixed speed ratio between the two super-turbochargers. The first super-turbocharger 1302 has an air intake conduit 1308 and compresses air, which is supplied to the engine from compressed air conduit 1310. Exhaust air conduit 1314 receives exhaust gas from the engine to run the turbine of the first super-turbocharger 1302. The exhaust gas exits the exhaust exit conduit 1312. The first super-turbocharger 1302 is coupled to the second super-turbocharger 1304 with a transfer gear 1306.

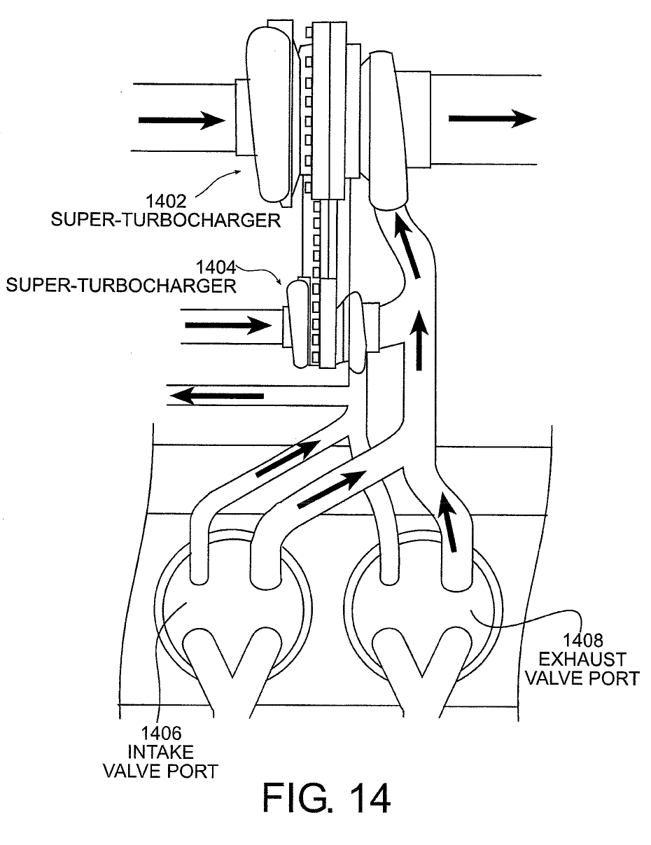

FIG. 14 illustrates another embodiment of an implementation of the use of two super-turbochargers, such as super-turbocharger 1402 and super-turbocharger 1404. A standard super-turbocharger does not do a good job of recovering the high-pressure pulse that comes out of the cylinder when the exhaust valve first opens. To improve this impulse pressure recovery, as illustrated in FIG. 14, the exhaust valve ports 1406, 1408 for each exhaust valve of a four-valve engine are separated. Using two super-turbochargers 1402, 1404, one exhaust port goes to each turbine. By changing valve timing, such that one valve is opened first and is ported to the high backpressure turbine, the pulse energy is recovered better. The first valve is closed quickly, and then the second valve is opened for the duration of the exhaust stroke. The second valve is ported to a very low backpressure turbine. This process reduces the work required by the piston to exhaust the cylinder. This process improves idle fuel efficiency, or at least eliminates parasitic losses at idle. The outlet of the high-pressure turbine 1404 also goes to the low-pressure turbine 1402. A catalytic converter (not shown) can also be disposed before the lower pressure turbine. The high pressure needed for the EGR loop is then provided for free.

In an alternate embodiment, a super-turbocharger may be used as an air pump for after treatment, as well as for the engine and eliminates the need for a separate pump just for the burner.

In another embodiment, a governor (not shown) is provided to prevent over-speeding, keeping the compressor out of a surge condition and controlling to the maximum efficiency of the turbine and compressor. A super-turbocharger can be unique from a normal turbocharger because the peak of the turbine efficiency and the peak of the compressor efficiency can be at the same speed. Controlling to this peak efficiency speed for a given boost requirement can be modeled and programmed into an electronic governor. An actuator can provide governing, although an actuator is not needed for the electric transmission.

In another embodiment, the oiling system for the super-turbocharger pulls a vacuum inside the housing, and therefore reduces aerodynamic losses of the high speed components.

In another alternate embodiment, a dual clutch super-turbocharger includes an automatically shifted manual transmission. This type of transmission shifts very smoothly because it has a clutch on both ends.

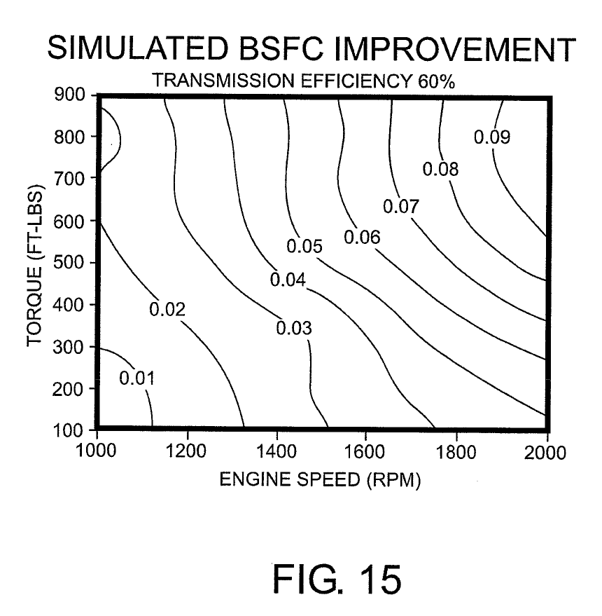

In another embodiment, traction drives for both the transmission and the speed reduction from the turbo shaft are used. With ball bearings, the traction fluid works as the lubricant as well. During supercharging, the system improves load acceptance, reduces soot emissions, provides up to 30% increase in low end torque and up to 10% increase in peak power. During turbo-compounding, the system provides improved fuel economy of up to 10% and controls backpressure. For engine downsizing, the system provides 30% more low end torque that allows the engine to be 30 to 50% smaller, having lower engine mass and improved vehicle fuel economy of 17% or more. FIG. 15 illustrates the simulated BSFC improvement for a natural gas engine.

Hence, a unique super-turbocharger is disclosed that uses a high speed traction drive having a fixed ratio that reduces the rotational mechanical speed of the turbine/compressor shaft to an rpm level that can be used by a continuously variable transmission that couples energy between a propulsion train and the turbine/compressor shaft. A uniqueness of the super-turbocharger design is that the transmission is disposed within the system. The continuously variable transmission is disposed within a lower portion of the super-turbocharger housing. The continuously variable transmission 116 provides the infinitely variable speed ratios that are needed to transfer rotational mechanical energy between the super-turbocharger and the engine. Either a geared continuously variable transmission can be used as continuously variable transmission 116 or a traction drive continuously variable transmission can be used. Hence, traction drives can be used for both the high speed traction drive 114 and the continuously variable transmission 116.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A super-turbocharger that is coupled to an engine comprising:
a turbine that generates turbine rotational mechanical energy from enthalpy of exhaust gas produced by said engine;
a compressor that compresses intake air and supplies compressed air to said engine in response to said turbine rotational mechanical energy generated by said turbine and engine rotational mechanical energy transferred from said engine;
a shaft having end portions that are connected to said turbine and said compressor, and a central portion having a shaft traction surface;
a traction drive disposed around said central portion of said shaft, said traction drive comprising:
a plurality of planetary rollers having a plurality of planetary roller traction surfaces that interface with said shaft traction surface so that a first plurality of traction interfaces exist between said plurality of planetary roller traction surfaces and said shaft traction surface;
a ring roller that is rotated by said plurality of planet rollers through a second plurality of traction interfaces;
a continuously variable transmission, that is mechanically coupled to said traction drive and said engine, that transfers turbine rotational mechanical energy to said engine and engine rotational mechanical energy to said super-turbocharger at operating speeds of said engine.

2. The super-turbocharger of claim 1 wherein said continuously variable transmission comprises a traction drive continuously variable transmission.

3. The super-turbocharger of claim 2 wherein said continuously variable transmission comprises a planetary ball bearing traction drive continuously variable transmission.

4. The super-turbocharger of claim 2 wherein said traction drive comprises a planetary traction drive that has at least two planet rollers.

5. The super-turbocharger of claim 4 wherein said planetary traction drive has at least three planet rollers.

6. The super-turbocharger of claim 4 wherein said planetary traction drive has a planet carrier on which said planet rollers are mounted.

7. The super-turbocharger of claim 6 wherein said planetary traction drive has multi-diameter planet rollers.

8. The super-turbocharger of claim 6 wherein said ring roller has a ring roller traction surface that interfaces with said plurality of planetary roller traction surfaces to create said second plurality of traction interfaces.

9. The super-turbocharger of claim 7 wherein said ring roller has a ring roller traction surface that interfaces with a plurality of additional planetary roller traction surfaces having a diameter that is less than said plurality of planetary roller traction surfaces to create said second plurality of traction interfaces.

10. A method of transferring rotational mechanical energy between a super-turbocharger and an engine comprising:
generating turbine rotational mechanical energy in a turbine from enthalpy of exhaust gas produced by said engine;
compressing intake air using a compressor to supply compressed air to said engine in response to said turbine rotational mechanical energy generated by said turbine and engine rotational mechanical energy generated by said engine;
providing a shaft having end portions that are connected to said turbine and said compressor, and a central portion having a shaft traction surface;
mechanically coupling a traction drive to said shaft traction surface of said shaft;
placing a plurality of planetary roller traction surfaces of a plurality of planetary rollers in contact with said shaft traction surface so that a plurality of first traction interfaces are created between said plurality of planetary roller traction surfaces and said shaft traction surface;
placing a ring roller in contact with said plurality of planetary rollers so that a plurality of second traction interfaces are created between said plurality of planet rollers and said ring roller;
mechanically coupling a continuously variable transmission to said traction drive and said engine to transfer said turbine rotational mechanical energy to said engine at operating speeds of said engine and engine rotational mechanical energy to said shaft at operating speeds of said compressor and said turbine.

11. The method of claim 10 wherein said process of transferring rotational mechanical energy between said super-turbocharger and said engine comprises transferring rotational mechanical energy through at least one mechanical device.

12. The method of claim 11 wherein said process of transferring rotational mechanical energy through at least one mechanical device comprises transferring rotational mechanical energy through a transmission of a vehicle.

13. The method of claim 11 wherein said process of transferring rotational mechanical energy through at least one mechanical device comprises transferring rotational mechanical energy to a propulsion train of a vehicle.

14. The method of claim 10 wherein said process of placing said ring roller in contact with said plurality of planet rollers comprises:
placing a ring roller traction surface of said ring roller in contact with said plurality of planetary roller traction surfaces to create said plurality of second traction interfaces.

15. The method of claim 10 wherein said process of placing said ring roller in contact with said plurality of planet rollers comprises:
placing a ring roller traction surface of said ring roller in contact with a plurality of additional planetary roller traction surfaces, having a diameter that is less than said plurality of planetary roller traction surfaces, to create said plurality of second traction interfaces.

16. The method of claim 10 wherein said process of mechanically coupling a continuously variable transmission to said traction drive comprises:
mechanically coupling a traction drive continuously variable transmission to said traction drive.

17. The method of claim 16 wherein said process of mechanically coupling a traction drive continuously variable transmission to said traction drive comprises:
mechanically coupling a planetary ball bearing continuously variable transmission to said traction drive.

18. The method of claim 16 wherein said process of mechanically coupling a traction drive to said shaft traction surface comprising:
mechanically coupling a planetary traction drive having at least three multi-diameter planet rollers.
